(19) United States
(12) Patent Application Publication
(10) Pub. No.: US 2011/0249565 A1
(43) Pub. Date: Oct. 13, 2011

(54) Systems and Methods for Adapting Network Capacity Assigned to a Partition

(76) Inventors: Paul Stjernholm, Lidingo (SE); Fredrik Persson, Marsta (SE); Lotta Voigt, Bromma (SE)

(21) Appl. No.: 13/139,386

(22) PCT Filed: Dec. 15, 2008
(86) PCT No.: PCT/SE2008/051455

§ 371 Date: Jun. 13, 2011

(51) Int. Cl. H04W 28/18; H04W 24/00

(52) U.S. Cl. 370/241

(57) ABSTRACT

The present application discloses systems and methods for adapting network capacity assigned to a partition. In some embodiment, the method includes: partitioning available capacity of a system into at least a first non-guaranteed bit rate (non-GBR) partition and a second non-GBR partition; determining that a performance goal for the first non-GBR partition is not met; and increasing a committed rate value associated with the first non-GBR partition and decreasing the committed rate value associated with the second non-GBR partition in response to determining that the performance goal is not met.

### TECHNICAL FIELD

The present invention relates to systems and method for adapting network capacity.

### BACKGROUND

Mobile communications systems (e.g., communications systems based on standards like GSM, WCDMA and LTE) typically employ an admission control system to reserve certain resources for guaranteed bit rate (GBR) bearers, which most often carry real time services having high demands on latency and throughput. Services without any guaranteed performance are carried on non-GBR bearers, which typically are not governed by admission control (e.g., no set up requests are rejected).

The available resources of a system can be divided into partitions, and each partition may be associated with particular users or bearers. Some partitions may be associated with GBR bearers (these partitions are known as GBR partitions), while the remaining resources are associated with non-GBR services. The remaining capacity is what is left when the admitted GBR bearers have been assigned their required resources. Several non-GBR partitions may be defined sharing the remaining capacity, where each partition is associated with committed rate (CR) value (e.g., a relative committed rate (RCR) value) defining its share of the remaining capacity. Because the RCR value is statically configured according to the expected traffic load and service distribution envisioned by the operator there is no possibility to adapt the RCR depending on the actual situation within each non-GBR partition to ensure a sufficient average bit rate for certain subscriber categories.

What is desired is an improved communication system that can adapt based on traffic conditions.

### SUMMARY

In one aspect, the invention provides a method for adapting network capacity assigned to a partition. In some embodiments the method includes: partitioning available capacity of a system into at least a first non-guaranteed bit rate (non-GBR) partition and a second non-GBR partition, wherein each of said partitions is associated with a committed rate value that defines the partition's share of the available capacity; determining that a performance goal for the first non-GBR partition is not met; and in response to determining that the performance goal is not met, (i) determining whether the committed rate value associated with the first non-GBR partition can be increased and (ii) increasing the committed rate value associated with the first non-GBR partition, thereby increasing the capacity of the first non-GBR partition, if it is determined that the committed rate value associated with the first non-GBR partition can be increased. The step of determining whether the committed rate value associated with the first non-GBR partition can be increased may include determining whether capacity can be borrowed from the second non-GBR partition.

In some embodiments, the method also includes: determining that the performance goal for the first non-GBR partition is met after increasing the committed rate value associated with the first non-GBR partition; and in response to determining that the performance goal for the first non-GBR partition is met, decreasing the committed rate value associated with the first non-GBR partition.

In some embodiments, the step of determining that the performance goal for the first non-GBR partition is not met comprises determining whether at least X bearers or X % of the bearers within the first non-GBR partition have not received a bit rate associated with the bearer (e.g., a prioritized bit rate (PBR) associated with the bearer), wherein X is a configuration parameter.

In other embodiments, the step of determining that the performance goal for the first non-GBR partition is not met comprises determining whether at least N mobile terminals or N % of mobile terminals using at least one bearer within the first non-GBR partition have not received a bit rate associated with the mobile terminal (e.g., a minimum acceptable average total bit rate for all non-GBR bearers associated with the mobile terminal), wherein N is a configuration parameter. In these embodiments, the step of determining that the performance goal for the first non-GBR partition is not met may further include: determining a first value representing the number of mobile terminals or percentage of mobile terminals using a bearer within the first non-GBR partition that have not received a bit rate associated with the mobile terminal; determining a second value representing the number of mobile terminals or percentage of mobile terminals using a bearer within the second non-GBR partition that have not received a bit rate associated with the mobile terminal; and comparing the first value with the second value.

In other embodiments, the step of determining that the performance goal for the first non-GBR partition is not met comprises determining whether at least N bearers or N % of the bearers within the first non-GBR partition are associated with a mobile terminal that has not received a bit rate associated with the mobile terminal (e.g., a minimum acceptable average total bit rate for all non-GBR bearers associated with the mobile terminal), wherein N is a configuration parameter. In these embodiments, the step of determining that the performance goal for the first non-GBR partition is not met may further include: determining a first value representing the number of bearers or percentage of bearers within the first non-GBR partition that are associated with a mobile terminal that has not received a bit rate associated with the mobile terminal; determining a second value representing the number of bearers or percentage of bearers within the second non-GBR partition that are associated with a mobile terminal that has not received a bit rate associated with the mobile terminal; and comparing the first value with the second value.

In another aspect, the present invention provides an improved base station. In some embodiments, the base station includes: a data storage system; computer software stored by the data storage system; and at least one processor for executing at least some of the computer software, wherein the computer software comprises: computer instructions for determining whether a performance goal for a non-GBR partition is not met; computer instructions configured to determine whether the committed rate value associated with the non-GBR partition can be increased in response to a determination that the performance goal is not met; and computer instructions configured to increase the committed rate value associated with the non-GBR partition, thereby increasing the capacity of the non-GBR partition, in response to a determination that that the performance goal is not met and a determination that the committed rate value associated with the non-GBR partition can be increased.

The above and other aspects and embodiments are described below with reference to the accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements.

FIG. 1 illustrates a portion of a communications system.

FIG. 2 illustrates that available capacity may be divided into a GBR partition with remaining capacity for non-GBR traffic.

FIG. 3 illustrates the available non-GBR capacity being divided into multiple non-GBR partitions.

FIG. 4 is a flow chart illustrating a process for adapting a non-GBR partition.

FIGS. 5-10 are flow charts illustrating different processes according to different embodiments of the invention.

FIG. 11 illustrates an exemplary data structure according to an embodiment of the invention.

FIG. 12 is a functional block diagram of a base station according to embodiments of the invention.

### DETAILED DESCRIPTION

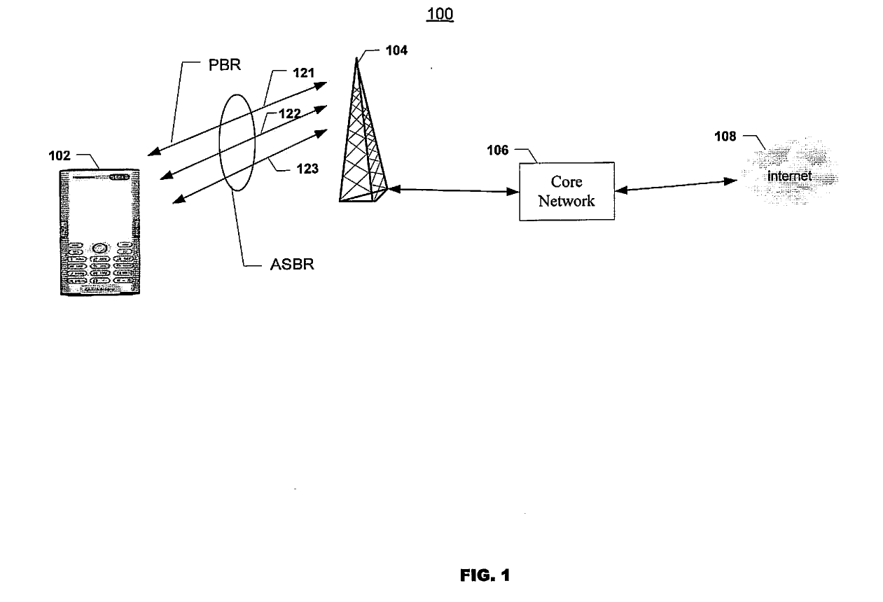

Referring now to FIG. 1, FIG. 1 illustrates a portion of a communications system 100, according to some embodiments. FIG. 1 shows a mobile terminal (a.k.a., user equipment (UE)) 102 in communication with a base station 104, which is in communication with a core network (CN) 106 (e.g., if base station 104 if part of an LTE network, base station 104 communicates with a core network node such as an mobility management entity (MME)). Core network 106 may provide access to a network 108 (e.g., the Internet). In some embodiments, when a user of UE 102 desires to use a service (e.g., make a voice call or download a video), UE 102 establishes a signaling connection with a base station (e.g., base station 104), if such a connection is not already established. Once the connection with the base station is established, UE 102 transmits a service request to CN 106. CN 106 may then select a bearer and transmit to base station 104 a request message which includes a request for resources for the selected bearer and quality of service (QoS) parameters associated with the selected bearer. Base station 104 may use the QoS parameters to assign the selected bearer to a partition.

FIG. 1 shows three non guaranteed bit rate (non-GBR) bearers 121, 122, and 123 for carrying traffic between UE 102 and base station 104. As illustrated, each bearer may be associated with an uplink prioritized bit rate (PBR) value and a downlink PBR that defines a minimum acceptable bit rate in the uplink and downlink, respectively. Additionally, UE 102 may be associated with an uplink and downlink aggregated sufficient bit rate (ASBR) value that defines a minimum acceptable total bit rate for all the non-GBR bearers associated with UE 102 in the uplink and downlink, respectively. An ASBR value associated with UE 102 may be signaled to base station 104 from CN 106. Alternatively, an ASBR value could also be provided as an operation and maintenance (O&M) value and be implicitly associated with UE 102 via an aggregated maximum bit rate (AMBR) value or the QoS profile, e.g. via the quality class indicator (QCI) value, associated with UE 102.

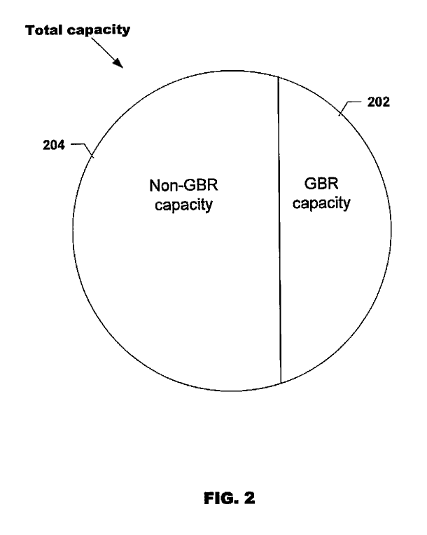

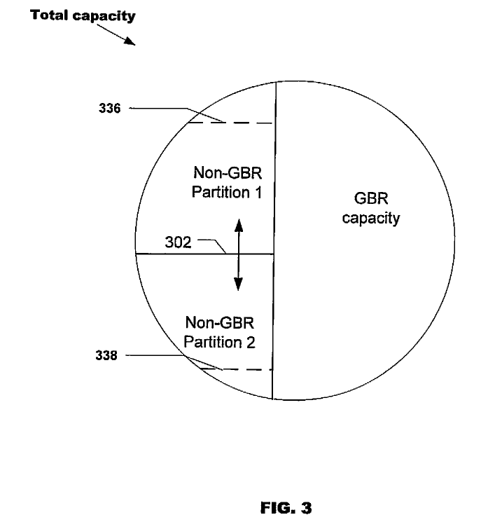

Referring now to FIG. 2, FIG. 2 illustrates the capacity of base station 104 and illustrates how this available capacity may be divided into GBR capacity 202 and non-GBR capacity 204. FIG. 3 illustrates that the non-GBR capacity 204 may be divided into two or more non-GBR partitions. In the example shown, non-GBR capacity 204 is subdivided into non-GBR partition 1 and non-GBR partition 2. Line 302 represents the boundary between the two non-GBR positions and the arrowed lines indicate that the boundary can move. That is, the capacity assigned to non-GBR partitions 1 and 2 may increase and decrease over time. In other words, the RCR value associated with each non-GBR partition may increase and decrease over time. In some embodiments, the capacity allocated to non-GBR partition 1 may not fall below a certain minimum threshold as represented by line 336 and the capacity allocated to non-GBR partition 2 may not fall below a certain minimum threshold as represented by line 338.

Embodiments of the present invention are concerned with determining whether to automatically adjust the RCR value for a non-GBR partition. For example, in terms of the diagram shown in FIG. 3, embodiments of the invention are concerned with determining whether to move line 302 up or down.

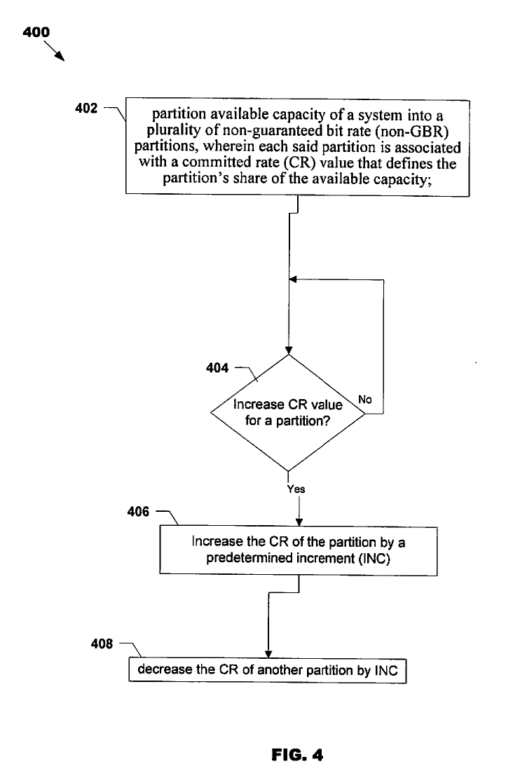

Shown in FIGS. 4-10 are flow charts illustrating various processes, each of which may be performed by base station 104 or other network node.

Referring now to FIG. 4, FIG. 4 is a flow chart illustrating a process 400 according to embodiments of the invention. Process 400 may begin in step 402, where multiple (i.e., two or more) non-GBR partitions are defined. Each of the non-GBR partitions is associated with a relative committed rate (RCR) value that defines the partition's share of the available capacity. In step 404, a decision is made as to whether or not to increase the RCR value of one of the non-GBR partitions. As described herein, this decision may be based on whether or not a performance goal for the non-GBR partition is met. If it is decided to increase the RCR value of a non-GBR partition (e.g., it is determined that the non-GBR's performance goal is not met), then process 400 proceeds to step 406, otherwise the process may return to step 404. In step 406, the RCR of the non-GBR partition is increased (e.g., it is increased by a predetermined increment (INC)). In step 408, the RCR of another of the non-GBR partitions is decreased (e.g., it is decreased by INC). In this manner, the system automatically increases the capacity of a non-GBR partition if the partition's performance goal is not met.

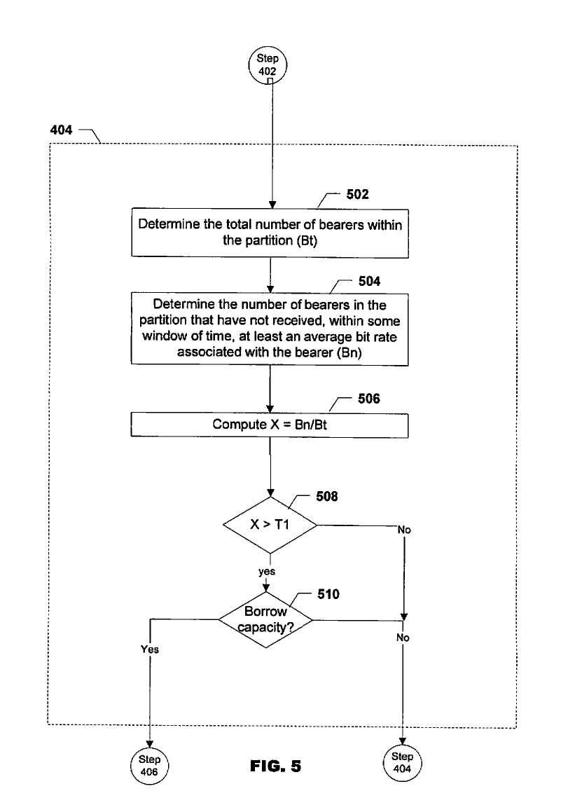

Referring now to FIG. 5, FIG. 5 is a flow chart illustrating a process, according to one embodiment, for determining whether or not to increase the RCR of a non-GBR partition (i.e., for performing step 404 of process 400). The process may begin in step 502, where the total number of bearers within the partition (Bt) is determined. In step 504, the number of bearers in the partition that have not received, within some window of time, at least an average bit rate associated with the bearer (Bn) is determined. For example, in step 504, the number of bearers in the partition that have not received their expected average PBR is determined. In step 506, Bn/Bt is calculated. In step 508, a determination is made as to whether Bn/Bt is greater than a predetermined threshold (T1). If Bn/Bt exceeds T1, then a determination is made as to whether there is another non-GBR partition from which capacity may be borrowed (step 510). If there is such another non-GBR partition, then the RCR of the target non-GBR partition should be increased (i.e., increasing the capacity of target partition would not cause the RCR value of another one of the non-GBR partitions to fall below a minimum value).

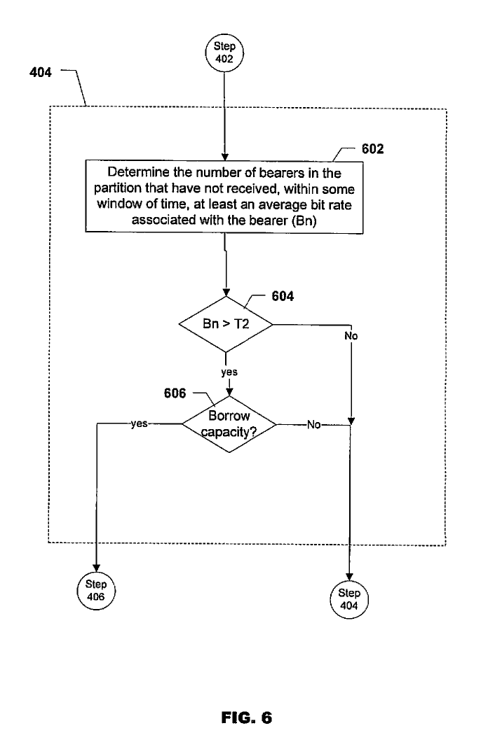

Referring now to FIG. 6, FIG. 6 is a flow chart illustrating a process, according to another embodiment, for determining whether or not to increase the RCR of a non-GBR partition (i.e., for performing step 404 of process 400). The process may begin in step 602, where the number of bearers in the partition that have not received, within some window of time, at least an average bit rate associated with the bearer (Bn) is determined. For example, in step 602, the number of bearers in the partition that have not received their expected average PBR is determined. In step 604, a determination is made as to whether Bn is greater than a predetermined threshold (T2). If Bn exceeds T2, then a determination is made as to whether there is another non-GBR partition from which capacity may be borrowed (step 606). If there is such another non-GBR partition, then the RCR of the target non-GBR partition should be increased (i.e., increasing the capacity of target partition would not cause the RCR value of another one of the non-GBR partitions to fall below a minimum value).

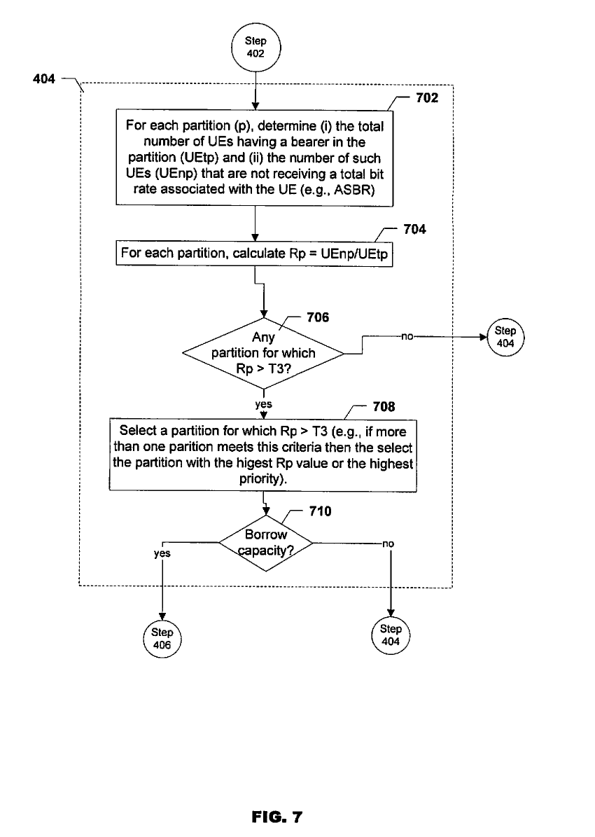

Referring now to FIG. 7, FIG. 7 is a flow chart illustrating a process, according to an embodiment, for performing step 404 of process 400. The process may begin in step 702, where, for each partition (p) the following is determined: (i) the total number of UEs (UEtp) having a bearer in the partition and (ii) the number of such UEs (UEnp) that have not received, within some window of time, an expected aggregate bit rate associated with the UE (e.g., an ASBR associated with the UE). In step 704, for each partition p, a value Rp is calculated, where Rp=UEnp/UEtp. In step 706, a determination is made as whether there is at least one partition having an Rp value that exceeds a threshold (T3). If there are no such partitions, then the process may perform step 404 again at a later time. If there is at least one such partition, then one of those partitions (i.e., a partition for which Rp>T3) is selected (step 708). For example, if there is more than one partition for which Rp>T3, then, in some embodiments, the partition with the highest priority or the highest Rp value is selected in step 708. In step 710, a determination is made as to whether there is another non-GBR partition from which capacity may be borrowed. If there is such another non-GBR partition, then the RCR of the non-GBR partition selected in step 708 is increased.

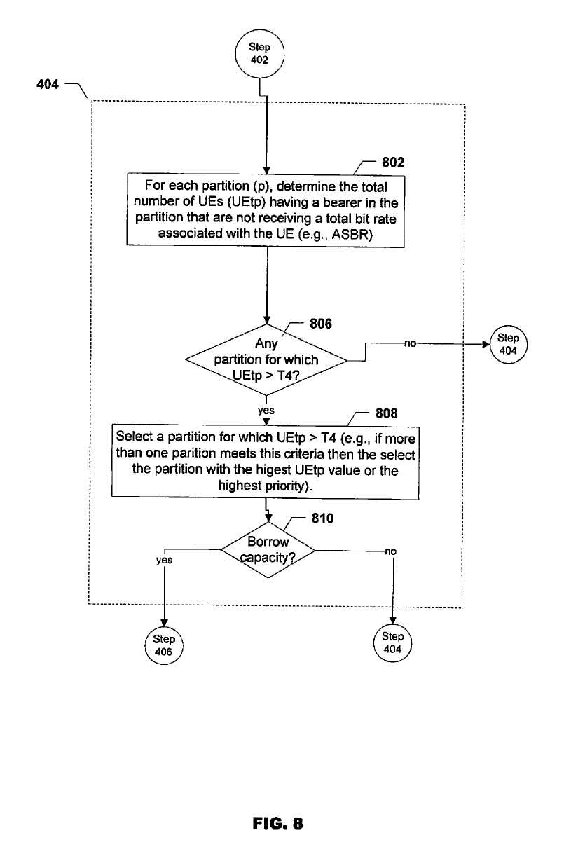

Referring now to FIG. 8, FIG. 8 is a flow chart illustrating a process, according to an embodiment, for performing step 404 of process 400. The process may begin in step 802, where, for each partition (p) the following is determined: the total number of UEs (UEtp) having a bearer in the partition that have not received, within some window of time, an expected aggregate bit rate associated with the UE (e.g., an ASBR associated with the UE). In step 806, a determination is made as whether there is at least one partition having a UEtp value that exceeds a threshold (T4). If there are no such partitions, then the process may perform step 404 again at a later time. If there is at least one such partition, then one of those partitions (i.e., a partition for which UEtp>T4) is selected (step 808). For example, if there is more than one partition for which UEtp>T4, then, in some embodiments, the partition with the highest priority or the highest UEtp value is selected in step 808. In step 810, a determination is made as to whether there is another non-GBR partition from which capacity may be borrowed. If there is such another non-GBR partition, then the RCR of the non-GBR partition selected in step 808 is increased.

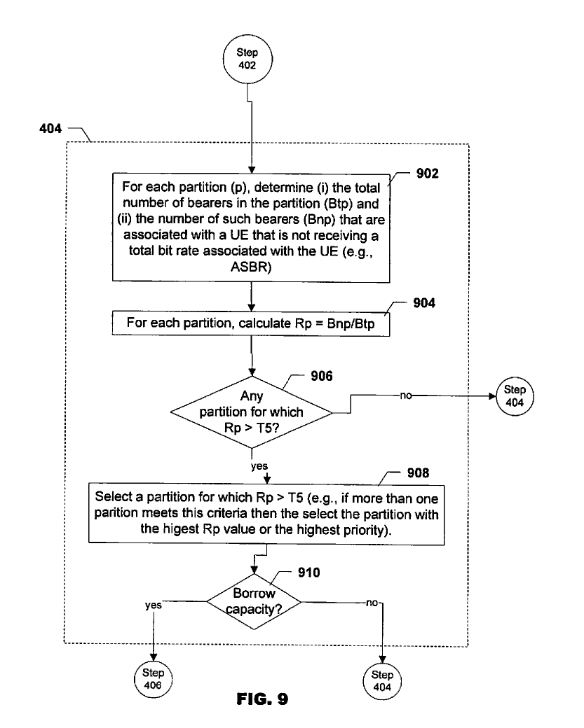

Referring now to FIG. 9, FIG. 9 is a flow chart illustrating a process, according to another embodiment, for performing step 404 of process 400. The process may begin in step 902, wherein, for each partition (p) the following is determined: (i) the total number of bearers in the partition (Btp) and (ii) the number of such bearers (Bnp) that are associated with a UE that has not received, within some window of time, an expected aggregate bit rate associated with the UE. In step 904, for each partition p, a value Rp is calculated, where Rp=Bnp/Btp. In step 906, a determination is made as whether there is at least one partition having an Rp value that exceeds a threshold (T5). If there are no such partitions, then the process may perform step 404 again at a later time. If there is at least one such partition, then one of those partitions (i.e., a partition for which Rp>T5) is selected (step 908). For example, if there is more than one partition for which Rp>T5, then, in some embodiments, the partition with the highest priority or the highest Rp value is selected in step 908. In step 910, a determination is made as to whether there is another non-GBR partition from which capacity may be borrowed. If there is such another non-GBR partition, then the RCR of the non-GBR partition selected in step 908 is increased.

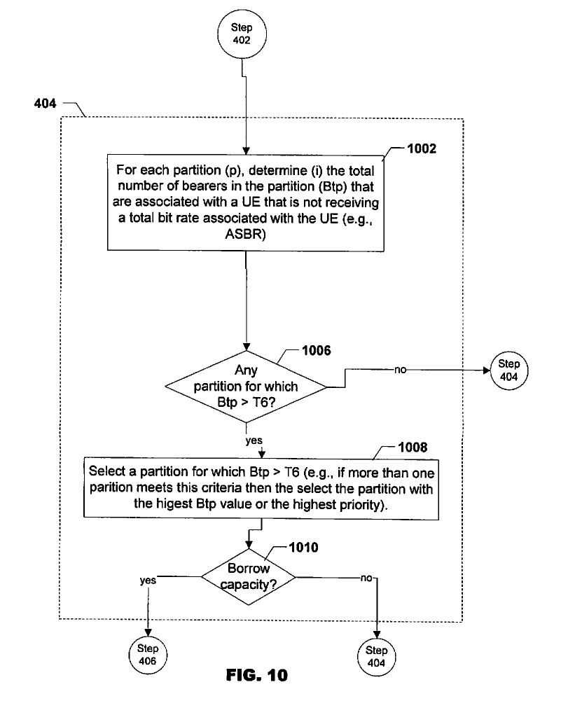

Referring now to FIG. 10, FIG. 10 is a flow chart illustrating a process, according to another embodiment, for performing step 404 of process 400. The process may begin in step 1002, wherein, for each partition (p) the following is determined: the total number of bearers in the partition (Btp) that are associated with a UE that has not received, within some window of time, an expected aggregate bit rate associated with the UE. In step 1006, a determination is made as whether there is at least one partition having an Btp value that exceeds a threshold (T6). If there are no such partitions, then the process may perform step 404 again at a later time. If there is at least one such partition, then one of those partitions (i.e., a partition for which Btp>T6) is selected (step 1008). For example, if there is more than one partition for which Btp>T6, then, in some embodiments, the partition with the highest priority or the highest Btp value is selected in step 1008. In step 1010, a determination is made as to whether there is another non-GBR partition from which capacity may be borrowed. If there is such another non-GBR partition, then the RCR of the non-GBR partition selected in step 1008 is increased.

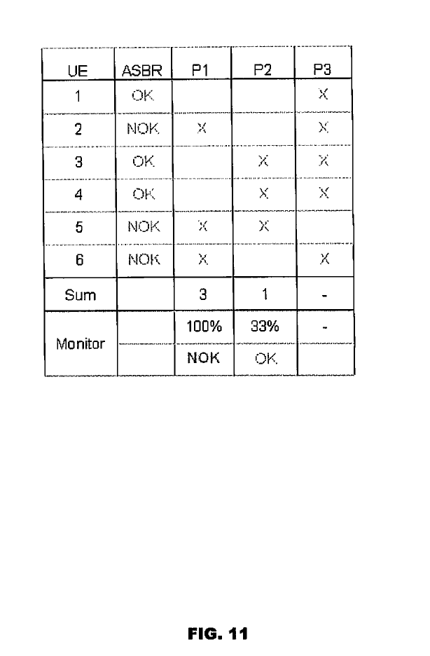

FIG. 11 shows an exemplary data structure that may be used in implementing the process shown in FIG. 7. The table shows which mobile terminals (or UEs) are using which partitions and shows the mobile terminals that are not receiving their ASBR. As seen in the example, all of the mobile terminals that are utilizing partition p1 have not received their ASBR. Accordingly, based on the logic shown in FIG. 7, the RCR value for partition p1 will increase.

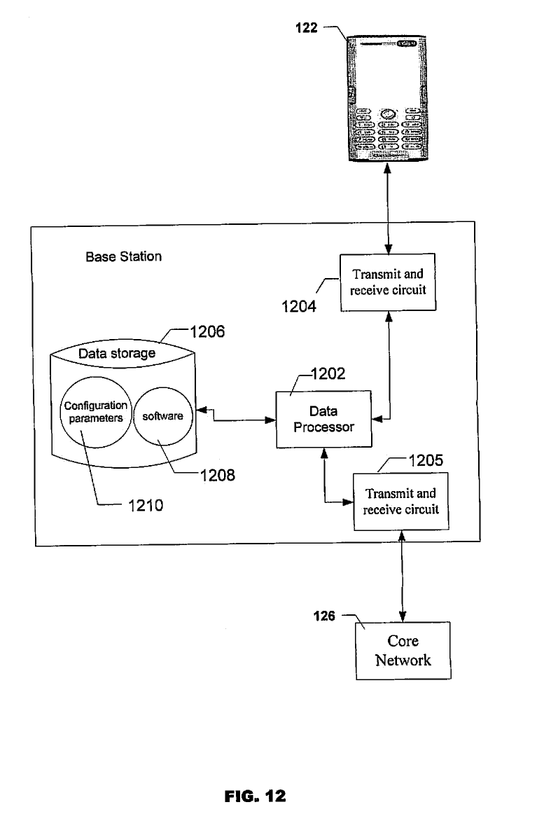

Referring now to FIG. 12, FIG. 12 is a functional block diagram of base station 104 according to some embodiments of the invention. As shown, base station 104 may comprise a data processing system 1202 (e.g., one or more microprocessors), a data storage system 1206 (e.g., one or more non-volatile storage devices) and computer software 1208 stored by the storage system 1206. Configuration parameters 1210 (e.g., the above mentioned performance criteria values and other configuration values) may also be stored in storage system 1206. Base station 104 also may comprise transmit/receive (Tx/Rx) circuitry 1204 for transmitting data to and receiving data from UE 102 and transmit/receive (Tx/Rx) circuitry 1205 for transmitting data to and receiving data from CN 106. Software 1208 is configured such that when processor 1202 executes software 1208, base station 104 performs steps described above with reference to the flow charts. For example, software 1208 may include: computer instructions for determining whether a performance goal for a non-GBR partition is not met; and computer instructions for increasing the committed rate value associated with the non-GBR partition and decreasing the committed rate value associated with another non-GBR partition in response to a determination that the performance goal is not met. The computer instructions for determining whether a performance goal for a non-GBR partition is not met may include computer instructions for performing the steps shown in FIGS. 5-10.

As described herein, the capacity assigned to a non-GBR partition may automatically increase if a certain criteria is not met (e.g., the number or percentage of mobile terminals using the partition that are not receiving their expected aggregate bit rate exceeds a threshold). After a non-GBR partition has been allocated more capacity, the extra capacity may be taken away as soon as the partition meets its performance criteria. In this way, the communication system can self-adapt based on performance.

While various embodiments of the present invention have been described above, it should be understood that they have been presented by way of example only, and not limitation. Thus, the breadth and scope of the present invention should not be limited by any of the above-described exemplary embodiments.

Additionally, while the processes described above and illustrated in the drawings are shown as a sequence of steps, this was done solely for the sake of illustration. Accordingly, it is contemplated that some steps may be added, some steps may be omitted, some steps may be performed in parallel, and the order of the steps may be re-arranged.

1-20. (canceled)

21. A method in a communication network for adapting network capacity assigned to a partition, comprising:
partitioning available capacity of a system into at least a first non-guaranteed bit rate (non-GBR) partition and a second non-GBR partition, wherein each of said partitions is associated with a committed rate value that defines the partition's share of the available capacity;
determining that a performance goal for the first non-GBR partition is not met; and
in response to determining that the performance goal is not met, determining whether the committed rate value associated with the first non-GBR partition can be increased and, if the committed rate value associated with the first non-GBR partition can be increased, increasing that committed rate value to thereby increase the capacity of the first non-GBR partition.

22. The method of claim 21, wherein determining that the performance goal for the first non-GBR partition is not met comprises determining that at least X bearers or X % of the bearers within the first non-GBR partition have not received a bit rate associated with the bearer, wherein X is a configuration parameter.

23. The method of claim 22, wherein the bit rate associated with a bearer is a prioritized bit rate (PBR).

24. The method of claim 21, wherein determining that the performance goal for the first non-GBR partition is not met comprises determining that at least N mobile terminals or N % of mobile terminals using at least one bearer within the first non-GBR partition have not received a bit rate associated with the mobile terminal, wherein N is a configuration parameter.

25. The method of claim 24, wherein determining that the performance goal for the first non-GBR partition is not met comprises:
determining a first value representing the number of mobile terminals or percentage of mobile terminals using a bearer within the first non-GBR partition that have not received a bit rate associated with the mobile terminal;
determining a second value representing the number of mobile terminals or percentage of mobile terminals using a bearer within the second non-GBR partition that have not received a bit rate associated with the mobile terminal; and
comparing the first value with the second value.

26. The method of claim 24, wherein the bit rate associated with a mobile terminal is a minimum acceptable average total bit rate for all non-GBR bearers associated with the mobile terminal.

27. The method of claim 21, wherein determining that the performance goal for the first non-GBR partition is not met comprises determining that at least N bearers or N % of the bearers within the first non-GBR partition are associated with a mobile terminal that has not received a bit rate associated with the mobile terminal, wherein N is a configuration parameter.

28. The method of claim 27, wherein determining that the performance goal for the first non-GBR partition is not met comprises:
determining a first value representing the number of bearers or the percentage of bearers within the first non-GBR partition that are associated with a mobile terminal that has not received a bit rate associated with the mobile terminal;
determining a second value representing the number of bearers or the percentage of bearers within the second non-GBR partition that are associated with a mobile terminal that has not received a bit rate associated with the mobile terminal; and
comparing the first value with the second value.

29. The method of claim 27, wherein the bit rate associated with a mobile terminal is a minimum acceptable average total bit rate for all non-GBR bearers associated with the mobile terminal.

30. The method of claim 21, further comprising:
determining that the performance goal for the first non-GBR partition is met after increasing the committed rate value associated with the first non-GBR partition; and
in response to determining that the performance goal for the first non-GBR partition is met, decreasing the committed rate value associated with the first non-GBR partition.

31. The method of claim 21, wherein determining whether the committed rate value associated with the first non-GBR partition can be increased comprises determining whether capacity can be borrowed from the second non-GBR partition.

32. A base station having an available capacity that is partitioned into at least a first non-guaranteed bit rate (non-GBR) partition and a second non-GBR partition, wherein each of said partitions is associated with a committed rate value that defines the partition's share of the available capacity, said base station comprising at least one processor configured to:
determine whether a performance goal for the first non-GBR partition is not met;
determine whether the committed rate value associated with the first non-GBR partition can be increased in response to a determination that the performance goal is not met; and
increase the committed rate value associated with the first non-GBR partition, thereby increasing the capacity of the first non-GBR partition, in response to a determination that that the performance goal is not met and a determination that the committed rate value associated with the first non-GBR partition can be increased.

33. The base station of claim 32, wherein the at least one processor is configured to determine whether the performance goal for the first non-GBR partition is not met by determining whether at least X bearers or X % of the bearers within the first non-GBR partition have not received a bit rate associated with the bearer, wherein X is a configuration parameter.

34. The base station of claim 33, wherein the bit rate associated with the bearer is a prioritized bit rate (PBR).

35. The base station of claim 32, wherein the at least one processor is configured to determine whether the performance goal for the first non-GBR partition is not met by determining whether at least N mobile terminals or N % of mobile terminals using at least one bearer within the first non-GBR partition have not received a bit rate associated with the mobile terminal, wherein N is a configuration parameter.

36. The base station of claim 35, wherein the at least one processor is configured to determine whether the performance goal for the first non-GBR partition is not met by:
determining a first value representing the number of mobile terminals or percentage of mobile terminals using a bearer within the first non-GBR partition that have not received a bit rate associated with the mobile terminal;
determining a second value representing the number of mobile terminals or percentage of mobile terminals using a bearer within the second non-GBR partition that have not received a bit rate associated with the mobile terminal; and
comparing the first value with the second value.

37. The base station of claim 35, wherein the bit rate associated with a mobile terminal is a minimum acceptable average total bit rate for all non-GBR bearers associated with the mobile terminal.

38. The base station of claim 32, wherein the at least one processor is configured to determine whether the performance goal for the first non-GBR partition is not met by determining whether at least N bearers or N % of the bearers within the first non-GBR partition are associated with a mobile terminal that has not received a bit rate associated with the mobile terminal, wherein N is a configuration parameter.

39. The base station of claim 38, wherein the at least one processor is configured to determine whether the performance goal for the first non-GBR partition is not met by:
determining a first value representing the number of bearers or percentage of bearers within the first non-GBR partition that are associated with a mobile terminal that has not received a bit rate associated with the mobile terminal;
determining a second value representing the number of bearers or percentage of bearers within the second non-GBR partition that are associated with a mobile terminal that has not received a bit rate associated with the mobile terminal; and
comparing the first value with the second value.

40. The base station of claim 38, wherein the bit rate associated with a mobile terminal is a minimum acceptable average total bit rate for all non-GBR bearers associated with the mobile terminal.

41. The base station of claim 32, wherein the at least one processor is configured to:
determine that the performance goal for the first non-GBR partition is met after increasing the committed rate value associated with the first non-GBR partition; and
decrease the committed rate value associated with the first non-GBR partition in response to a determination that the performance goal for the first non-GBR partition is met.

42. The base station of claim 32, wherein the at least one processor is configured to determine whether the committed rate value associated with the first non-GBR partition can be increased by determining whether capacity can be borrowed from the second non-GBR partition.
